(19) United States
(12) Patent Application Publication
(10) Pub. No.: US 2009/0110908 A1
(43) Pub. Date: Apr. 30, 2009

(54) METHOD OF MANUFACTURING DISPERSION TYPE INORGANIC ELECTROLUMINESCENCE DEVICE AND DISPERSION TYPE INORGANIC ELECTROLUMINESCENCE DEVICE

(75) Inventors: Shang Hyeun PARK, Yongin-si (KR); Ji Beom YOO, Suwon-si (KR); Mun Ja KIM, Suwon-si (KR); Min Jong BAE, Yongin-si (KR); Tae Won JEONG, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/114,478

(22) Filed: May 2, 2008

(30) Foreign Application Priority Data
Oct. 24, 2007 (KR) 10-2007-0107258

(51) Int. Cl. H05B 33/14; B32B 5/16; B05D 5/12

(52) U.S. Cl. 428/323; 427/66

(57) ABSTRACT

A method of manufacturing a dispersion type inorganic electroluminescence device and a dispersion type inorganic electroluminescence device including a light-emitting layer and a dielectric layer, which are integrated, are disclosed. The method is directed to the manufacture of a dispersion type inorganic electroluminescence device, in which phosphor particles are coated with a metal oxide precursor using ultrasonic waves, after which the phosphor particles coated with the metal oxide precursor are disposed between a transparent electrode and an upper electrode, forming a light-emitting layer and a dielectric layer, which are integrated. The dispersion type inorganic electroluminescence device includes a plurality of phosphor particles coated with a metal oxide precursor, disposed between a transparent electrode and an upper electrode, thereby providing a light-emitting layer and a dielectric layer, which are integrated.

This application claims priority to Korean Patent Application No. 2007-107258 filed on Oct. 24, 2007, and all the benefits accruing therefrom under 35 U.S.C. §119, the contents of which in its entirety are herein incorporated by reference.

### BACKGROUND OF THE INVENTION

1. Field of the Invention

The present invention relates to a method of manufacturing a dispersion type inorganic electroluminescence device and a dispersion type inorganic electroluminescence device. More particularly, to a method of manufacturing a dispersion type inorganic electroluminescence device, in which phosphor particles are coated with a metal oxide precursor using ultrasonic waves, after which the phosphor particles coated with the metal oxide precursor are disposed between a transparent electrode and an upper electrode, thus, forming a light-emitting layer and a dielectric layer, which are integrated. Therefore, simplifying the overall manufacturing process and decreasing the manufacturing cost. Furthermore, enlarging the contact interface between the light-emitting layer and the dielectric layer, thus increasing the luminance of the device, and to a dispersion type inorganic electroluminescence device in which a light-emitting layer and a dielectric layer are integrated.

2. Description of the Related Art

Electroluminescence has been applied in various fields, including illumination and back lighting devices. However, the application field thereof is very limited, attributable to luminance and lifespan problems. Thus, conventionally, an inorganic electroluminescence device (hereinafter, referred to as an “inorganic EL device”) has been developed, which includes a uniform planar light source, is flexible, light, slim, short and small, and has high resistance to variation in temperature, and is being used as a backlight device of key pads for mobile phones. Furthermore, the inorganic EL device is suitable for being mounted to various advertisement boards, illumination systems, and vehicles. Unlike thin film EL devices or hybrid EL devices, dispersion type inorganic EL devices are advantageous because these devices may be applied to a flexible substrate and may be manufactured to have a large size, and the entire process thereof may be realized through printing, thus decreasing the manufacturing cost.

Therefore, it would be advantageous to development a method of manufacturing a dispersion type inorganic EL device having high luminance, which reduces manufacturing costs.

### BRIEF SUMMARY OF THE INVENTION

The present invention has made an effort to solve the above-stated problems and aspects of the present invention provide a method of manufacturing a dispersion type inorganic EL device, which is able to simplify the overall manufacturing process, decrease the manufacturing cost and increase the luminance and stability of the device, and a dispersion type inorganic EL device having increased luminance and stability.

In an exemplary embodiment, the present invention provides a method of manufacturing a dispersion type inorganic EL device which includes mixing a metal oxide precursor solution with phosphor particles and coating the phosphor particles with the metal oxide precursor, drying the phosphor particles coated with the metal oxide precursor, and disposing the phosphor particles coated with the metal oxide precursor between a transparent electrode and an upper electrode to form a light-emitting layer and a dielectric layer which are integrated.

In another exemplary embodiment, the present invention provides a dispersion type inorganic EL device which includes a transparent electrode, an upper electrode, and a plurality of phosphor particles, which are coated with a metal oxide precursor, disposed between the transparent electrode and the upper electrode to form a light-emitting layer and a dielectric layer which are integrated.

### BRIEF DESCRIPTION OF THE DRAWINGS

The above and/or other aspects, features and advantages of the present invention will become apparent from the following detailed description when taken in conjunction with the accompanying drawings, in which:

FIG. 1 is a schematic cross-sectional view illustrating a conventional dispersion type inorganic EL device;

FIG. 2 is a schematic cross-sectional view illustrating an exemplary embodiment of a dispersion type inorganic EL device according to the present invention;

FIG. 3 is a transmission electron micrograph (TEM) illustrating an exemplary embodiment of a phosphor coated with a metal oxide precursor, prepared as described in Example 1; and

FIG. 4 is a graph illustrating luminance versus driving voltage for the dispersion type inorganic EL devices obtained in Examples 1 to 4 and Comparative Example 1.

### DETAILED DESCRIPTION OF THE INVENTION

The invention is described more fully hereinafter with reference to the accompanying drawings, in which exemplary embodiments of the invention are shown. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

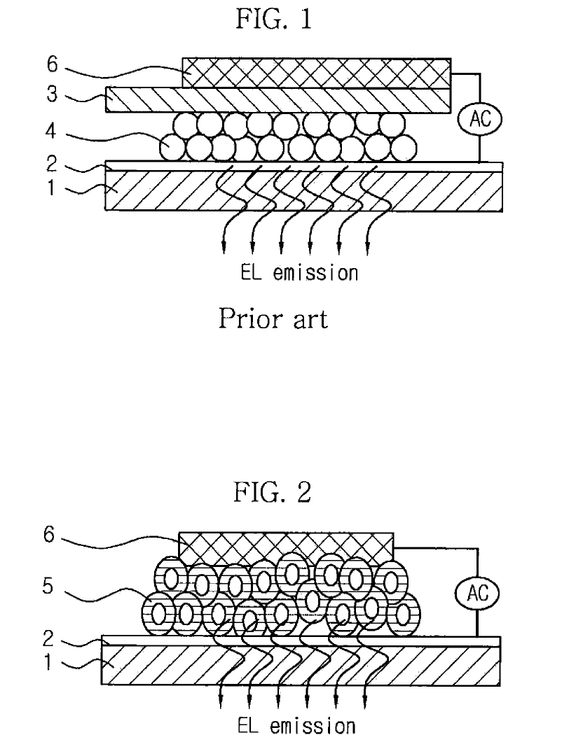

Hereinafter, the present invention will be explained in detail with reference to the accompanying drawings. FIG. 1 is a schematic cross-sectional view illustrating a conventional dispersion type inorganic EL device. Referring to FIG. 1, a conventional method of manufacturing the conventional dispersion type inorganic EL device comprises forming a transparent electrode 2 on a substrate 1, forming a light-emitting layer 4 on the transparent electrode 2, forming a dielectric layer 3 on the light-emitting layer 4, and stacking an upper electrode 6 on the dielectric layer 3, thereby forming the inorganic EL device.

In order to simplify the foregoing complex manufacturing method., exemplary embodiments of the present invention are characterized in that the light-emitting layer 4 and the dielectric layer 3, which are conventionally separately formed through a two-step process, are formed to be integrated by disposing a plurality of phosphor particles coated with a metal oxide precursor between the transparent electrode 2 and the upper electrode 6 as shown in FIG. 2. Further, the operation of coating the phosphor particles with the metal oxide precursor is performed using ultrasonic waves or by means of a mechanical stirrer, a magnetic stirrer or a homogenizer, thus simplifying the manufacturing method. Further, a device having a large size may be easily manufactured using the phosphor particles, each of which is coated, and also, a dielectric film, which is very fragile, is not used, thus facilitating the fabrication of a flexible display.

In the manufacturing method according to an exemplary embodiment of the present invention, in order to integrate the light-emitting layer 4 and the dielectric layer 3 of the dispersion type inorganic EL device, the phosphor particles are coated with the metal oxide precursor. A metal oxide precursor solution and phosphor powder are prepared and then mixed, after which ultrasonic waves are applied thereto, thereby coating the phosphor particles with the metal oxide precursor. As such, as the reactor, i.e., an ultrasonic bath, is used. Thereafter, the solution including the phosphor particles coated with the metal oxide precursor is subjected to filtering to remove the solvent, and the phosphor particles coated with the metal oxide precursor are dried. The drying may be conducted under conditions of room temperature, but the present invention is not limited thereto. The phosphor particles coated with the metal oxide precursor are disposed on the transparent electrode 2, which is formed on the substrate 1, after which the upper electrode 6 is disposed on the phosphor particles, thereby manufacturing the dispersion type inorganic EL device in which the light-emitting layer and the dielectric layer are integrated. According to an exemplary embodiment, the operation of disposing the phosphor particles coated with the metal oxide precursor on the transparent electrode 2 is not limited hereto, and may include an operation of forming a light-emitting layer using a phosphor. For example, according to an exemplary embodiment, an operation of mixing a phosphor with an organic binder to prepare a paste composition, applying the paste composition to the transparent electrode 2, and drying it in an oven to remove the organic binder may be performed.

According to an exemplary embodiment, the organic binder is used such that the phosphor particles coated with the metal oxide precursor are applied in the form of the paste composition on the transparent electrode. However, the present invention is not limited hereto, alternatively, one or more resins selected from cyanogenated cellulose resin, including cyanoethyl cellulose resin, cyanogenated pullulan resin, including cyanoethyl pullulan resin, fluorinated vinylidene rubber, fluorinated vinylidene-based copolymer rubber resin, and cyanogenated polyvinylalcohol may be used.

According to an exemplary embodiment, the metal oxide precursor, which is applied on the phosphor particles, plays a role as a dielectric, thereby enabling the integration of the dielectric layer and the light-emitting layer in the dispersion type inorganic EL device. The integrated light-emitting layer, which is formed between the transparent electrode 2 and the upper electrode 6, that is, between the positive electrode and the negative electrode, has a structure such that electric charges are rapidly transferred to the phosphor particles and such that the luminescence center of the phosphor particles, each of which is coated with the dielectric, is easily excited by electrons so that more electrons contribute to light emission. The dispersion type inorganic EL device manufactured by the method according to the current exemplary embodiment exhibits high luminance. Further, the thickness of the light-emitting layer including the phosphor particles coated with the metal oxide precursor, disposed between the transparent electrode and the upper electrode, is controlled, thus making it easy to adjust the emission efficiency of the EL device.

According to an exemplary embodiment, me phosphor may include a host material doped with an activator which determines the color thereof The host material, which is the matrix of the phosphor, includes a high band gap, and is capable of being excited in a high electric field, and includes a lattice that is able to receive a visible light-emitting activator. According to an exemplary embodiment, the host material includes, but is not limited to, compounds of Group 12-16, 13-15, and 14-14 in the periodic table and mixtures thereof, which may be appropriately selected depending on the emission wavelength. For example, the host material may be ZnS, ZnSe, GaAs, GaAlAs, GaAsP, AlGaInP, AlAs, GaP, AlP, SiC, GaN, GaInN, GaAlN, and combinations thereof.

According to an exemplary embodiment the phosphor includes, is not limited to, ZnS:Cu, ZnS:Cu,Mn,Cl, ZnS:Sm,F, ZnS:Sm,Cl, and CaS:Eu for emitting a red color, ZnS:Cu,Al, ZnS:Tb,F, and CaS:Ce for emitting a green color, ZnS:Tm,F, SrS:Ce, ZnS/SrS:Ce, CSGa₂S₄:Ce, ZnS:Cu,Cl, and ZnS:Cu,I for emitting a blue color, and ZnS:Mn for emitting a yellow color.

Further, according to an exemplary embodiment, the metal oxide precursor exhibits a resistivity of metal oxide of approximately 10⁵ Ω·cm or more, for example. According to an exemplary embodiment, The metal oxide includes, one or more selected from the group including SiO₂, Al₂O₃, BaTiO₃, and TiO₂. The precursor of the metal oxide may be one which is well-known in the art, and examples thereof include, but are not limited to, SOG (spin on glass) and TEOS (tetraethyl orthosilicate).

According to an exemplary embodiment, the coating of the phosphor particles with the metal oxide precursor may be performed using ultrasonic waves, or alternatively by means of a mechanical stirrer, a magnetic stirrer, or a homogenizer.

According to an exemplary embodiment, the metal oxide precursor is applied is of a thickness of approximately 10 nm to 500 nm on the phosphor particles. The thickness of the metal oxide precursor, which is applied on the phosphor particles, is easily controlled through the adjustment of the number of times the coating operation is repeated.

According to an exemplary embodiment any material may be used for the transparent electrode 2 which is well-known in the art, and examples thereof include, but are not limited to, one or more selected from a group including metal oxides, conductive polymers, nano-structures, and crystals, which may be appropriately selected depending on the end use thereof. The metal oxide for the transparent electrode 2 may be one or more selected from a group including indium tin oxide (ITO), indium zinc oxide (IZO), InSnO, ZnO, SnO₂, NiO, and Cu₂SrO₂. Specific examples of the conductive polymer include polyacetylene polymers, such as polydiphenylacetylene, poly(t-butyl)diphenylacetylene, poly(trifuoromethy)diphenylacetylene, poly(bistrifluoromethyl)acetylene, polybis(t-butyldiphenyl)acetylene, poly(trimethylsilyl)diphenylacetylene, poly(carbazole)diphenylacetylene, polydiacetylene, polyphenylacetylene, polypyrdineacetylene, polymethoxyphenylacetylene, polymethylphenylacetylene, poly(t-butyl)phenylacetyene, polynitrophenylacetylene, poly(trifluoromethyl)phenylacetylene, poly(trimethylsilyl)phenylacetylene, and derivatives thereof. In addition, examples of other usable conductive polymers include polyaniline, polythiophene, polypyrrole, polysilane, polystyrene, polyfuran, polyindole, polyazulene, polyphenylene, polypyridine, polybipyridine, polyphthalocyanine, polyphenylene vinylene, a mixture of PEDOT (polyethylenedioxythiophene)/PSS (polystyrenesulfonate), and dervatives thereof.

According to an exemplary embodiment, the material for the upper electrode 6 may be one which is well-known in the art. More particularly, the upper electrode may include conductive metals or oxides thereof, specific examples thereof including, but not being limited to, nickel (Ni), platinum (Pt), gold (Au), silver (Ag), iridium (Ir), and aluminum (Al).

In the current exemplary embodiment, the transparent electrode 2 or the upper electrode 6 may be formed by printing or sputtering, for example.

The thickness of the light-emitting layer and the dielectric layer, which are integrated, is set within the range from approximately 15 μm to approximately 60 μm, and preferably from approximately 20 μm to approximately 50 μm, so that the dispersion type inorganic EL device manufactured by the method of the current exemplary embodiment, exhibits appropriate luminance.

According to another exemplary embodiment, the method further comprises forming a dielectric layer on the upper side or the upper and lower sides of the light-emitting layer and the dielectric layer, which are integrated, either before and after, or only after forming the light-emitting layer and the dielectric layer, which are integrated.

According to an exemplar embodiment in the inorganic EL device manufactured by the method disclosed herein, when a polyethylene terephthalate (“PET”) film is used as the substrate, instead of a glass substrate, a flexible display may be fabricated.

FIG. 2 is a schematic cross-sectional view illustrating an exemplary embodiment of a dispersion type inorganic EL device, comprising an integrated light-emitting where an light-emitting layer and a dielectric layer are integrated, according to an exemplary embodiment. Referring to FIG. 2, the dispersion type inorganic EL device has a structure comprising a substrate 1, a transparent electrode 2, an integrated light-emitting layer 5, which is formed on the transparent electrode 2, and an upper electrode 6, in that order. The integrated light-emitting layer 5 comprises a plurality of phosphor particles coated with a metal oxide precursor, thereby simultaneously realizing functions as the light-emitting layer and the dielectric layer. Thus, the contact interface between the phosphor particles and the dielectric is enlarged and thus, light is emitted at a lower driving voltage. Therefore, the dispersion type inorganic EL device includes a higher luminance than a conventional dispersion type inorganic EL device. Further, since the phosphor particles are coated with the metal oxide precursor, the damage to the phosphor due to a high electric field may be prevented, and the phosphor may be stably protected from moisture in the air, thereby improving the reduction in luminance caused by extended operation of the EL device, thus prolonging the lifetime of the device.

According to the current exemplary embodiment the type of substrate 1 used for the dispersion type inorganic EL device is not limited, and examples thereof include, however, are not limited to, silica, glass, a PET film, and plastic, which may be appropriately selected by one skilled in the art depending on the end use. According to an exemplary embodiment, when a flexible material such as a PET film is used, a flexible device may be realized. The thickness of the substrate 1 may be appropriately set by one skilled in the art depending on the end use.

The transparent electrode 2 may be made of a material which is well-known in the art, and examples thereof include, however, are not limited to, one or more selected from the group including metal oxides, conductive polymers, nanostuctures, and crystals, which may be appropriately selected depending on the end use. The metal oxide for the transparent electrode 2 may be one or more selected from the group including indium tin oxide (ITO), indium zinc oxide (IZO), InSnO, ZnO, SnO₂, NiO, and Cu₂SrO₂. Specific examples of the conductive polymer include polyacetylene polymers, such as polydiphenylacetylene, poly(t-butyl)diphenylacetylene, poly(trifluoromethyl)diphenylacetylene, poly(bistrifluoromethyl)acetylene, polybis(t-butyldiphenyl)acetylene, poly(trimethylsilyl)diphenylacetylene, poly(carbazole)diphenylacetylene, polydiacetylene, polyphenylacetylene, polypyridineacetylene, polymethoxyphenylacetylene, polymethylphenylacetylene, poly(t-butyl)phenylacetylene, polynitrophenylacetylene, poly(trifluoromethyl)phenylacetyene, poly(trimethylsilyl)phenylacetylene, and derivatives thereof. In addition, examples of other usable conductive polymers include polyaniline, polythiophene, polypyrrole, polysilane, polystyrene, polyfuran, polyindole, polyazulene, polyphenylene, polypyridine, polybipyridine, polyphthalocyanine, polyphenylene vinylene, a mixture of PEDOT (polyethylenedioxythiophene)/PSS (polystyrenesuffonate), and derivatives thereof. According to an exemplary embodiment, the thickness of the transparent electrode 2 is set within the range from approximately 800 Å to approximately 1500 Å.

The metal oxide precursor, which plays a role as a dielectric of the integrated light-emitting layer 5, exhibits a resistivity of metal oxide of approximately 10⁵ Ω·cm or more. The metal oxide include, but are not limited to, one or more selected from the group including SiO₂, Al₂O₃, BaTiO₃, and TiO₂. Any precursor of the metal oxide may be used which is well-known in the art and examples thereof include, but are not limited to, SOG (spin-on glass) and TEOS (tetraethyl orthosilicate). The thickness of the metal oxide precursor applied on the phosphor particles is set within the range from approximately 10 nm to approximately 500 nm.

In the current exemplary embodiment the phosphor included in the integrated light-emitting layer 5 includes a host material doped with an activator which determines the color thereof. The host material, which is the matrix of the phosphor includes a high band gap, is capable of being excited in a high electric field, and includes a lattice which is able to receive a visible light-emitting activator. Examples of the host material include, but are not limited to, compounds of Group 12-16, 13-15, and 14-14 in the periodic table and mixtures thereof, which may be appropriately selected depending on the emission wavelength. Specific examples thereof include, but are not limited to, ZnS, ZnSe, GaAs, GaAlAs, GaAsP, AlGaInP, AlAs, GaP, AlP, SiC, GaN, GaInN, GaAlN, and combinations thereof.

Specific examples of the phosphor used in the example embodiments include, but are not limited to, ZnS:Cu, ZnS:Cu,Mn,Cl, ZnS:Sm,F, ZnS:Sm,Cl, and CaS:Eu for emitting a red color, ZnS:Cu,Al, ZnS:Tb,F, and CaS:Ce for emitting a green color, ZnS:Tm,F, SrS:Ce, ZnS/SrS:Ce, CaGa₂S₄:Ce, ZnS:Cu,Cl, and ZnS:Cu,I for emitting a blue color, and ZnS:Mn for emitting a yellow color.

In order to realize appropriate luminance of the dispersion type inorganic EL device, according to an exemplary embodiment, the thickness of the integrated light-emitting layer 5 is preferably set within the range from approximately 15 μm to approximately 60 μm, and more preferably of approximately 20 μm to approximately 50 μm.

According to an exemplary embodiment the upper electrode 6 may be of a material which is well-known in the art, and more particularly, may include conductive metals or oxides thereof, specific examples thereof including, but not being limited to, nickel (Ni), platinum (Pt), gold (Au), silver (Ag), indium (Ir), and aluminum (Al).

The dispersion type inorganic EL device according to the an exemplary embodiment, may further include a dielectric layer on the upper side or the upper and lower sides of the integrated light-emitting layer 5.

A better understanding of the exemplary embodiments will be described in more detail with reference to the following examples. However, these examples are given merely for the purpose of illustration and are not to be construed as limiting the scope of the embodiments.

### EXAMPLE 1

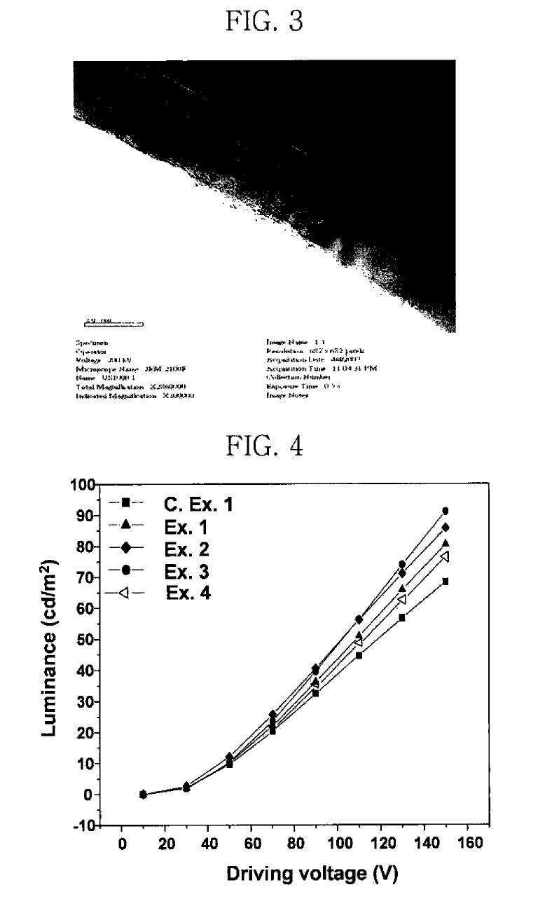

4.1 g of SOG (spin-on glass, 512B, Honeywell) was placed in a sonicator (SH-2100, SAE HAN Ultrasonic Co.), after which ultrasonic waves were applied for 5 hours while 2 g of ZnS:Cu,Cl phosphor particles were added, thus coating the phosphor particles with the SOG. After the reaction, the mixture solution was filtered using filter paper and was then dried to thus, remove the solvent, after which the phosphor particles coated with the SOG were dried at room temperature, thus manufacturing a light-emitting source in which the dielectric and the phosphor particles were integrated. The TEM of the phosphor coated with the SOG is illustrated in FIG. 3. With reference to FIG. 3, it can be seen that the metal oxide precursor was uniformly applied on the phosphor particles.

On a glass substrate (soda lime glass) having a thickness of 1.8 mm, ITO was applied through sputtering, thus forming a transparent electrode having a thickness of 1500 Å. Thereafter, 30 g of the phosphor particles coated with the SOG, which were previously prepared, and 12 g of cyanoethyl pullulan resin were mixed using a softener, and the resultant mixture was applied to a thickness of 25 μm on the transparent electrode through spin coating at 1000 rotations per minute (rpm), and was then dried in an electric oven at 130° C. for 30 min. Subsequently, aluminum (Al) was applied to a thickness of 1500 Å through sputtering and was then dried at 130° C. for 30 min, thus forming an upper electrode, thereby manufacturing an inorganic EL device.

### EXAMPLE 2

An inorganic EL device was manufactured in the same manner as in Example 1, with the exception that a series of processes of loading the phosphor particles coated with the SOG, prepared as in Example 1, into the sonicator having the SOG, coating the phosphor particles with the SOG, removing the solvent, and conducting drying was conducted two additional times (total: three times).

### EXAMPLE 3

An inorganic EL device was manufactured in the same manner as in Example 1, with the exception that a series of processes of loading the phosphor particles coated with the SOG, prepared as in Example 1, into the sonicator having the SOG, coating the phosphor particles with the SOG, removing the solvent, and conducting drying was conducted four additional times (total: five times).

### EXAMPLE 4

An inorganic EL device was manufactured in the same manner as in Example 1, with the exception that TEOS (tetraethyl orthosilicate, Sigma Aldrich) was used as a material for coating the ZnS:Cu,Cl phosphor particles.

### COMPARATIVE EXAMPLE 1

On a glass substrate (soda lime glass) having a thickness of 1.8 mm, ITO was applied through sputtering, thus forming a transparent electrode having a thickness of 1500 Å. Thereafter, 30 g of ZnS:Cu,Cl phosphor particles were printed to thus form a light-emitting layer having a thickness of 25 μm, and SiO₂ was subjected to plasma enhanced chemical vapor deposition (PECVD) to thus form a dielectric layer having a thickness of 3000 Å. Subsequently, aluminum (Al) was applied to a thickness of 1500 Å through sputtering and was then dried at 130° C. for 30 min, thus forming an upper electrode, thereby manufacturing an inorganic EL device.

### EXPERIMENTAL EXAMPLE 1

The luminance versus driving voltage for the devices obtained in the examples and comparative example was measured. The results are shown in FIG. 4. The voltage and current which were applied to the connected upper and lower electrodes, were measured using an oscilloscope (Agilent, Infiniium Oscilloscope), and the luminance was measured using a luminance colorimeter (TOPCON, BM-7). The frequency applied upon the measurement was 400 Hz.

With reference to FIG. 4, the inorganic EL devices manufactured through the method disclosed herein could be seen to exhibit luminance superior to that of the device manufactured in the comparative example, which is the conventional method.

While the present invention has been shown and described with reference to some exemplary embodiments thereof, it should be understood by those of ordinary skill in the art that various changes in form and detail may be made therein without departing from the spirit and scope of the present invention as defined by the appending claims.

What is claimed is:

1. A method of manufacturing a dispersion type inorganic electroluminescence device, comprising:
mixing a metal oxide precursor solution with phosphor particles and coating the phosphor particles with the metal oxide precursor;
drying the phosphor particles coated with the metal oxide precursor: and
disposing the phosphor particles coated with the metal oxide precursor between a transparent electrode and an upper electrode, and forming a light-emitting layer and a dielectric layer, which are integrated.

2. The method of claim 1, wherein the metal oxide precursor exhibits a resistivity of metal oxide of approximately 10⁵ Ω·cm or more.

3. The method of claim 1, wherein coating of the phosphor particles with the metal oxide precursor is conducted by using at least one of a stirrer using ultrasonic waves, a mechanical stirrer, a magnetic stirrer, or a homogenizer.

4. The method of claim 1, wherein coating the phosphor particles with the metal oxide precursor is conducted by applying the metal oxide precursor on the phosphor particles in a thickness ranging from approximately 10 nm to approximately 500 nm.

5. The method of claim 2, wherein the metal oxide is at least one selected from a group comprises SiO₂, Al₂O₃, BaTiO₃, and TiO₂ or any combination thereof.

6. The method of claim 1, further comprising:
forming a dielectric layer on an upper side or on upper and lower sides of the light-emitting layer and the dielectric layer, which are integrated, either before and after or only after forming the light-emitting layer and the dielectric layer, which are integrated.

7. A dispersion type inorganic electroluminescence device, comprising:
a transparent electrode;
an upper electrode; and
a plurality of phosphor particles, which are coated with a metal oxide precursor, disposed between the transparent electrode and the upper electrode, to provide a light-emitting layer and a dielectric layer, which are integrated.

8. The device of claim 7, wherein the metal oxide precursor exhibits a resistivity of metal oxide of approximately 10⁵ Ω·cm or more.

9. The device of claim 7, wherein a thickness of the metal oxide precursor applied on the phosphor particles ranges from approximately 10 nm to approximately 500 nm.

10. The device of claim 8 wherein the metal oxide is at least one selected from a group comprising SiO₂, Al₂O₃, BaTiO₃, and TiO₂ or any combination thereof.

11. The device of claim 7 further comprising:
a dielectric layer formed on an upper side or on both upper and lower sides of the light-emitting layer and the dielectric layer, which are integrated.

12. A method of manufacturing a dispersion type inorganic electroluminescence device having a transparent electrode and an upper electrode, the method comprising:
mixing phosphor particles with a metal oxide precursor and coating the phosphor particles with the metal oxide precursor in the form of a paste composition using an organic binder and applying the paste combination to the transparent electrode;
drying the phosphor particles coated with the metal oxide precursor to remove the organic binder and to form an integrated light-emitting layer and dielectric layer between the transparent electrode and the upper electrode.
wherein the metal oxide precursor exhibits a resistivity of metal oxide of approximately 10⁵ Ω·cm or more.

13. The method of claim 12, wherein coating of the phosphor particles with the metal oxide precursor is conducted by using at least one of a stirrer using ultrasonic waves, a mechanical stirrer, a magnetic stirrer, or a homogenizer.

14. The method of claim 12, wherein coating the phosphor particles with the metal oxide precursor is conducted by applying the metal oxide precursor on the phosphor particles in a thickness ranging from approximately 10 nm to approximately 500 nm.

15. The method of claim 13, wherein the metal oxide is at least one selected from a group comprises SiO₂, Al₂O₃, BaTiO₃, and TiO₂ or any combination thereof.
